(19) United States
(12) Patent Application Publication
(10) Pub. No.: US 2023/0251721 A1
(43) Pub. Date: Aug. 10, 2023

(54) Gesture-Based and Video Feedback Machine

(71) Applicant: Vipin Singh, Metuchen, NJ (US)

(72) Inventor: Vipin Singh, Metuchen, NJ (US)

(21) Appl. No.: 17/577,214

(22) Filed: Jan. 17, 2022

(51) Int. Cl. G06F 3/01; G06V 40/20; G06F 16/73; G06F 16/63; G06F 3/16

(52) U.S. Cl. CPC G06F 3/017; G06F 3/167; G06F 16/63; G06F 16/73; G06V 40/28

(57) ABSTRACT

A system and method for providing gesture-based and video-based query feedback received from a user utilizes a system having a video display device, a microphone, a memory having instructions stored thereon, and a processor configured to execute the instructions on the memory to cause the system to perform a method. The processor executing instructions cause the system to select a first set of gestures for use when interacting with the user, determine whether the user understands the first set of gestures, and when the user understands the first set of gestures, processor executing additional instructions to further cause the system to output one or more feedback queries as query audio or video data to the user, capture one or more input gestures as video data in response to the one or more feedback queries, identify the one or more response gestures within the video data, and when the one or more gestures identified within the video data are recognized as corresponding to one or more gestures from the first set of gestures, record a query response corresponding to the recognized one or more gestures as a feedback response to the one or more feedback queries.

### TECHNICAL FIELD

This application relates in general to a system and method for providing non-written feedback, and more specifically, to a system and method providing gesture-based and video based query feedback.

### BACKGROUND

Current devices can capture audio and video feedback in the moment from customers, employees, citizens etc. Currently, these devices may sometimes use passive feedback collection via online and offline survey tools and other platforms. However, these devices are often not able to adequately support various tasks depending on the objective of feedback collection. Billions of people around the world who cannot read or write but can speak a native language fluently currently have difficulty successfully interacting with existing feedback collection devices. As such, many people are not able to provide useful feedback via automated devices and applications available on mobile devices such as smartphones, tablets, and similar computing devices and their specific needs cannot be determined by potential service providers.

Therefore, a need exists for a system and method providing gesture-based query feedback according to the present invention. The present invention attempts to address the existing limitations in a system and method for providing gesture-based query feedback according to the principles and example embodiments disclosed herein.

### SUMMARY

In accordance with the present invention, the above and other problems are solved by providing gesture-based query feedback according to the principles and example embodiments disclosed herein.

In one embodiment, the present invention is a system for providing gesture-based query feedback. A system and method for providing gesture-based query feedback received from a user utilizes a system having a video display device, a microphone, a memory with instructions stored thereon, and a processor configured to execute the instructions on the memory to cause the system to perform a method. The processor executing instructions can cause the system to select a first set of gestures for use when interacting with the user, determine whether the user understands the first set of gestures, and when the user understands the first set of gestures, execute additional instructions to further cause the system to output one or more feedbacks as output data to the user, capture one or more input gestures as gesture video data in response to the one or more feedback queries, identify one or more response gestures within the video data, and when one or more gestures identified within the video data are recognized as corresponding to one or more gestures from the first set of gestures, record a query response corresponding to the recognized one or more gestures as a feedback response to one or more feedback queries.

In another embodiment, the present invention is a method for providing gesture-based query feedback. The method selects a first set of gestures for use when interacting with the user, determines whether the user understands the first set of gestures, and when the user understands the first set of gestures, the method further outputs one or more feedback queries as query audio data to the user, captured one or more input gestures as gesture video data in response to the one or more feedback queries, identifies the one or more response gestures within the video data, and when the one or more gestures identified within the video data are recognized as corresponding to one or more gestures from the first set of gestures, records a query response corresponding to the recognized one or more gestures as a feedback response to the one or more feedback queries.

The foregoing has outlined rather broadly the features and technical advantages of the present invention in order for the detailed description of the invention that follows is better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates a system for providing gesture-based query feedback according to the present invention.

FIG. 2a is a block diagram illustrating an exemplary hardware architecture of a computing device.

FIG. 2b is a block diagram illustrating an exemplary logical architecture for a client device.

FIG. 2c is a block diagram showing an exemplary architectural arrangement of clients, servers, and external services.

FIG. 2d is another block diagram illustrating an exemplary hardware architecture of a computing device.

FIG. 3 illustrates an example embodiment of a processing system providing gesture-based and video-based query feedback according to the present invention.

FIG. 4 illustrates a computing system of software components of a system providing gesture-based and video-based query feedback according to the present invention.

FIGS. 5a-b illustrates flowcharts corresponding to a method performed by software components of a system providing gesture-based and video-based query feedback according to the present invention.

### DETAILED DESCRIPTION

This application relates in general to a system and method for providing non-written user interaction, and more specifically, to a system and method for providing gesture-based and video-based query feedback according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps, or components, but do not preclude the presence or addition of one or more other features, steps, or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact but may be approximated and/or larger or smaller, as desired, reflecting tolerances, conversion factors, rounding off, measurement error and the like, and other factors known to those of skill. Further, unless otherwise stated, the term “about” shall expressly include “exactly.”

The term “mobile application” refers to an application executing on a mobile device such as a smartphone, tablet, and/or web browser on any computing device.

The terms “feedback provider” and “user” refer to an entity, e.g. a human, using the gesture-based and video-based feedback system including any software or smart device application(s) associated with the invention. The term user herein refers to one or more users.

The term “connection,” refers to connecting any component as defined below by any means, including but not limited to, a wired connection(s) using any type of wire or cable for example, including but not limited to, coaxial cable(s), fiberoptic cable(s), and ethernet cable(s) or a wireless connection(s) using any type of frequency/frequencies or radio wave(s). Some examples are included below in this application.

The term “invention” or “present invention” refers to the invention being applied for via the patent application with the title “Gesture-Based and Video-Based Feedback Machine.” Invention may be used interchangeably with machine.

The terms “communicate”, or “communication” refer to any component(s) connecting with any other component(s) in any combination for the purpose of the connected components to communicate and/or transfer data to and from any components and/or control any settings.

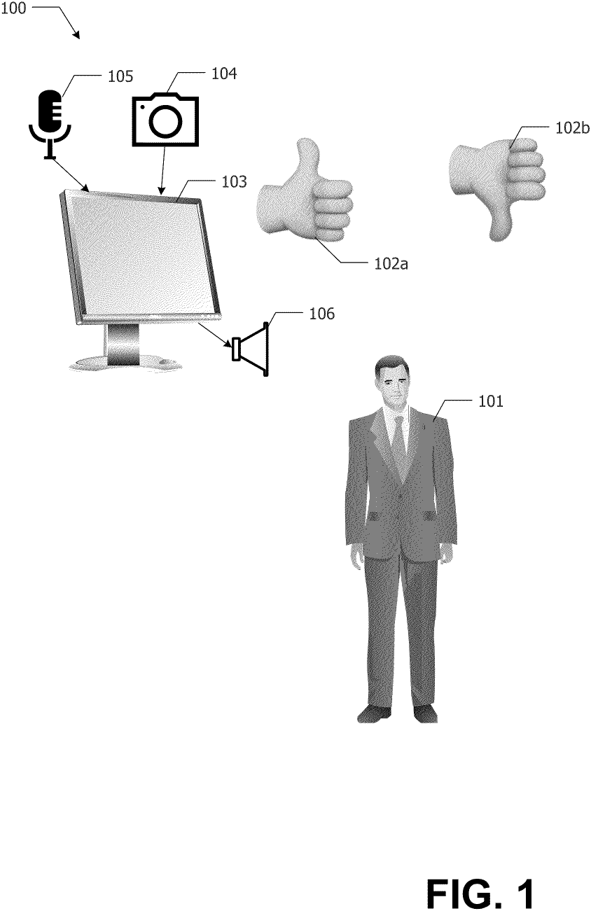

In general, the present disclosure relates to a system and method for providing secure data storage. To better understand the present invention, FIG. 1 illustrates a system for providing gesture-based and video-based query feedback according to the present invention. A user feedback system 100 obtains gesture-based feedback from a user 101 using a computing system 115 having a display device 103, a camera 104, a microphone 105, and one or more speakers 106. The user feedback system 100 provides information and queries and instructions to the user 101 by presenting non-written language information such as pictures, videos, icons, graphics, and similar visual items onto the display device 103. The feedback provider 101 may respond with voice-based responses captured by the microphone 105 and with physical gestures 102 captured by the camera 104.

The user feedback system 100 may begin an interaction with the feedback provider 101 by performing a set of gesture training exercises. The user feedback system 100 typically queries the feedback provider 101 with questions that require one of a small number of possible answers. Questions that may be answered with a “yes” or a “no” are one example. A choice between 2-4 possible responses that also may be answered by a “none” or “not applicable” is a second example.

The user feedback system 100 performs training exercises by offering the feedback provider 101 a set of gestures 102 to perform in response to possible answers that are applicable to the questions being asked to obtain the user’s feedback. The user feedback system 100 may show images and videos of people performing the gestures 102. The feedback provider 101 may be asked to perform each gesture 102 a number of times while the actions are obtained by the camera 104 and the microphone 105. After a preset number of gestures 102 have been processed, the user feedback system 100 may ask the feedback provider 101 to then provide a random sequence of the gestures 102 that may be used to evaluate the user feedback system’s 100 ability to detect the feedback provider’s 101 response correctly. If the user feedback system 100 cannot detect the gestures 102 correctly, the feedback provider 101 may be asked to repeat the training until the user feedback system 100 may accurately detect the responses greater than a specified percentage of attempts.

After the training and successful evaluation of the performance of the user feedback system 100 has concluded, the user feedback system 100 may begin a series of queries that the feedback provider 101 may respond to using the trained gestures 102. The user feedback system 100 may follow a sequence of queries that are based upon a pre-defined script of questions as well as a sequence of queries that are dependent upon the previously provided responses.

The user feedback system 100 does not assume that the feedback provider 101 is sufficiently fluent in a particular language to understand the training and then the queries. The user feedback system 100 obtains the responses without requiring the feedback provider 101 to use a keyboard or touch screen that may be problematic depending upon the location and environment of the user feedback system 100. The user feedback system 100 may need to be secured within a locked enclosure that does not permit users to physically interact with the user feedback system 100. The user feedback system 100 also utilizes the gestures 102 to eliminate the problems that may arise from different languages, dialects, accents, and similar technical issues encountered with a voice recognition-based system.

Additionally, the use of gestures 102 in the place of voice inputs permits the queries to be developed agnostic of the language used by the user feedback system 100. To communicate with the feedback provider 101 in their spoken language, the auditory messages output may be simply recorded statements obtained in the local language. As such, a product supplier based in one country that provides its products around the world may develop a single set of queries that allow its customers to respond to the product supplier about issues encountered, new features that may be needed, and similar desired feedback in a language agnostic fashion. The user feedback system 100 may use the camera 104 and the microphone 105 to record the interaction with the feedback provider 101 to permit higher quality feedback being captured via the performance of the user feedback system 100. These recorded interactions may also be useful for seeking clarification of responses when later review of the results requires nuance or more information.

The user feedback system 100 may be integrated into kiosks deployable into user locations around the world. The user feedback system 100 also may be integrated into mobile applications that obtain feedback and store via the Internet 110. The creation and configuration of the queries, the responses, and the gestures 102 to be used may occur once and be deployed with a recorded set of audio data in a native language, or possibly multiple languages, that the feedback provider 101 may select.

The user feedback system 100 may be placed at strategic locations depending on the objective of feedback collection and will have the ability to identify feedback using specific questions and simple responses in the form of customizable graphics, including thumbs down, thumbs up, you rock etc., and the feedback provider may do so with or without touching any buttons or screens. The feedback provider will then be asked if he or she would like to provide additional audio or video feedback to provide some more context which will then be transcribed and assessed, using machine learning and artificial intelligence technologies for sentiment, such as positive, negative, happy, upset etc. and related analysis.

The gathered information may automatically be summarized into topical dashboards for the decision makers, deployers, governments, and merchants. The present invention may have payment acceptance capabilities as well as the ability to process and upload the required information to an access controlled or public server on the web or can be saved locally, depending on the storage capacity of the device.

The present invention also may be deployed for individual use via an application which can be accessed on a personal device, for example smart phone computer or tablet, as this invention may help people who cannot read or write but can speak a native language fluently. Mobile application developers may include the present invention within their applications as a mechanism to obtain feedback from users of these mobile applications.

The invention comprises a user feedback system 100 to interact with users. The computing system may use any type of network such as a single network, multiple networks of a same type, or multiple networks of different types which may include one or more of a direct connection between devices, including but not limited to a local area network (LAN), a wide area network (WAN) ( for example, the Internet), a metropolitan area network (MAN), a wireless network (for example, a general packet radio service (GPRS) network), a long term evolution (LTE) network, a telephone network (for example, a Public Switched Telephone Network or a cellular network), a subset of the Internet, an ad hoc network, a fiber optic network (for example, a fiber optic service (often known as FiOS) network), or any combination of the above networks.

Smart devices mentioned herein the present application may also use one or more sensors to receive or send signals, such as wireless signals for example, Bluetooth™, wireless fidelity, infrared, Wi-Fi, or LTE. Any smart device mentioned in this application may be connected to any other component or smart device via wired communications (e.g., conductive wire, coaxial cable, fiber optic cable, ethernet cable, twisted pair cable, transmission line, waveguide, etc.), or a combination of wired and wireless communications. The invention’s method and/or system may use a single server device or a collection of multiple server devices and/or computer systems.

The systems and methods described above, may be implemented in many different forms of applications, software, firmware, and hardware. The actual software or smart device application codes or specialized control software, hardware or smart device application(s) used to implement the invention’s systems and methods is not limiting the implementation. Thus, the operation and behavior of the systems and methods were described without reference to the specific software or firmware code. Software, smart device application(s), firmware, and control hardware can be designed to implement the systems and methods based on the description herein.

While all of the above functions are described may be provided to users via a mobile application on a smartphone, one of ordinary skill will recognize that any computing device including tablets, laptops, and general purpose computing devices may be used as well. In at least one embodiment, all of the services described herein are provided using web pages being accessed from the web server 201 using a web browser such as Safari™, Firefox™, Chrome™, DuckDuckGo™, Edge™ and the like. All of the screen examples described herein show user interface elements that provide the functionality of the present invention. The arrangement, organization, presentation, and use of particular user input/output (I/O) elements including hyperlinks, buttons, text fields, scrolling lists, and similar I/O elements are shown herein for example embodiments only to more easily convey the features of the present invention. The scope of the present invention should not be interpreted as being limited by any of these elements unless expressly recited within the attached claims.

For the purposes of the example embodiment of FIG. 1, various functions are shown to be performed on different programmable computing devices that communicate with each other over the Internet 105. These computing devices may include smartphones 101a, laptop computers 101b, tablets (not shown), and similar devices so long as the disclosed functionality of the mobile application described herein is supported by the particular computing device. One of ordinary skill will recognize that this functionality is grouped as shown in the embodiment for clarity of description. Two or more of the processing functions may be combined onto a single processing machine. Additionally, it may be possible to move a subset of processing from one of the processing systems shown here and retain the functionality of the present invention. The attached claims recite any required combination of functionality onto a single machine, if required, and all example embodiments are for descriptive purposes.

For all of the above devices that are in communication with each other, some, or all of them need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects, and in order to more fully illustrate one or more aspects. Similarly, although process steps, method steps, algorithms or the like may be described in a sequential order, such processes, methods, and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method or algorithm is carried out or executed. Some steps may be omitted in some aspect or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example, an end-user computer system, a client computer, a network server or other server system, a mobile computing device (e.g., tablet computing device, mobile phone, smartphone, laptop or other appropriate computing device), a consumer electronic device, a music player or any other suitable electronic device, router, switch or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines or other appropriate virtual environments).

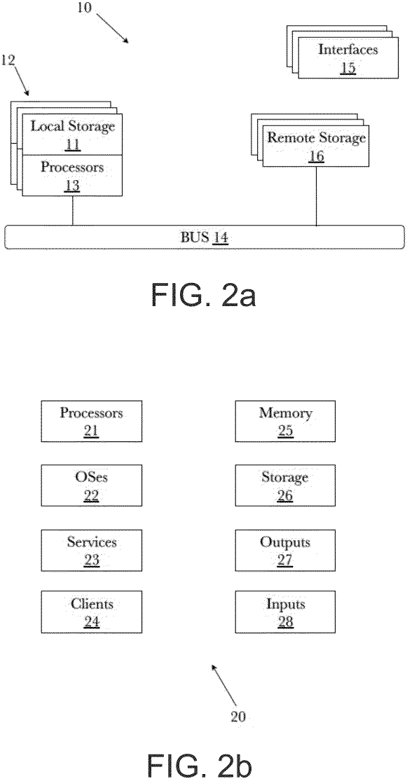

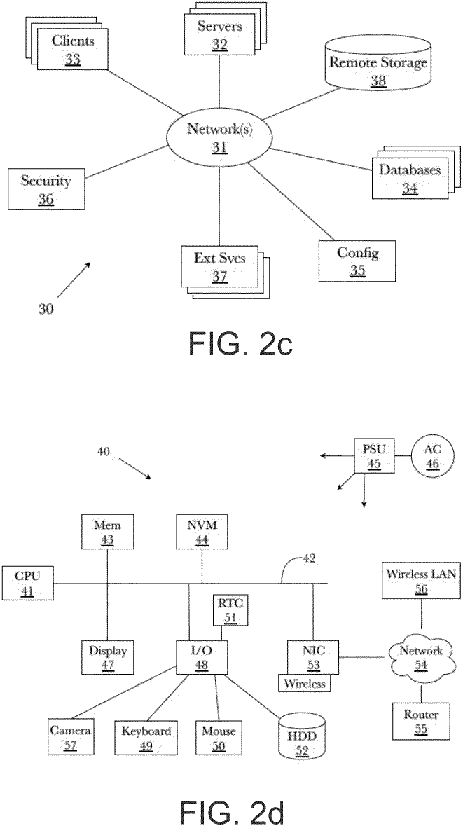

Referring now to FIG. 2a, there is a block diagram depicting an exemplary computing device 10 suitable for implementing at least a portion of the features or functionalities disclosed herein. A computing device 10 may be, for example, any one of the computing machines listed in the previous paragraph, or indeed any other electronic device capable of executing software- or hardware-based instructions according to one or more programs stored in memory. A computing device 10 may be configured to communicate with a plurality of other computing devices, such as clients or servers, over communications networks such as a wide area network, a metropolitan area network, a local area network, a wireless network, the Internet, or any other network, using known protocols for such communication, whether wireless or wired.

In one aspect, the computing device 10 includes one or more central processing units (CPU) 12, one or more interfaces 15, and one or more buses 14 (such as a peripheral component interconnect (PCI) bus). When acting under the control of appropriate software or firmware, the CPU 12 may be responsible for implementing specific functions associated with the functions of a specifically configured computing device or machine. For example, in at least one aspect, a computing device 10 may be configured or designed to function as a server system utilizing a CPU 12, local memory 11 and/or remote memory 16, and interface(s) 15. In at least one aspect, a CPU 12 may be caused to perform one or more of the different types of functions and/or operations under the control of software modules or components, which for example, may include an operating system and any appropriate applications software, drivers, and the like.

A CPU 12 may include one or more processors 13 such as for example, a processor from one of the Intel, ARM, Qualcomm, and AMD families of microprocessors. In some aspect, processors 13 may include specially designed hardware such as application-specific integrated circuits (ASICs), electrically erasable programmable read-only memories (EEPROMs), field-programmable gate arrays (FPGAs), and so forth, for controlling operations of a computing device 10. In a particular aspect, a local memory 11 (such as non-volatile random access memory (RAM) and/or read-only memory (ROM), including for example, one or more levels of cached memory) may also form part of a CPU 12. However, there are many different ways in which memory may be coupled to a system 10. Memory 11 may be used for a variety of purposes such as, for example, caching and/or storing data, programming instructions, and the like. It should be further appreciated that a CPU 12 may be one of a variety of system-on-a-chip-(SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may, for example, support other peripherals used with a computing device 10. Among the interfaces that may be provided are ethernet interfaces, frame relay interfaces, cable interfaces, DSL interfaces, token ring interfaces, graphics interfaces, and the like. In addition, various types of interfaces may be provided such as, for example, universal serial bus (USB), serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast ethernet interfaces, gigabit ethernet interfaces, serial ATA (SATA) or external SATA (ESATA) interfaces, high-definition multimedia interfaces (HDMI), digital visual interfaces (DVI), analog or digital audio interfaces, asynchronous transfer mode (ATM) interfaces, high-speed serial interfaces (HSSI), point of sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 2a illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and a server system (such as a server system described in more detail below).

Regardless of network device configuration, the system of an aspect may employ one or more memories or memory modules (for example, remote memory block 16 and local memory 11) configured to store data, program instructions for the general-purpose network operations or other information relating to the functionality of the aspects described herein (or any combinations of the above). Program instructions may control execution of or comprise an operating system and/or one or more applications, for example. Memory 16 or memories 11, 16 also may be configured to store data structures, configuration data, encryption data, historical system operations information or any other specific or generic non-program information described herein.

Because such information and program instructions may be employed to implement one or more systems or methods described herein, at least some network device aspects may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device) or they may be removable such as swappable flash memory modules (such as “thumb drives” or other removable media designed for rapidly exchanging physical storage devices), “hot-swappable” hard disk drives or solid state drives, removable optical storage disks, or other such removable media, and that such integral and removable storage media may be utilized interchangeably. Examples of program instructions include both object code, such as may be produced by a compiler, machine code, such as may be produced by an assembler or a linker, byte code, such as may be generated by for example by a JAVA™ compiler and may be executed using a JAVA™ virtual machine or equivalent, or files containing higher level code that may be executed by the computer using an interpreter (for example, scripts written in Python™, Perl™, Ruby™, Groovy™, or any other scripting language).

In some aspects, systems may be implemented on a standalone computing system. Referring now to FIG. 2b, there is a block diagram depicting a typical exemplary architecture of one or more aspects or components thereof on a standalone computing system. A computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the LINUX™ operating system, ANDROID™ operating system, or the like. In many cases, one or more shared services 23 may be operable in system 20 and may be useful for providing common services to client applications 24. Services 23 may, for example, be WINDOWS™ services, user-space common services in a LINUX™ environment or any other type of common service architecture used with an operating system 22. Input devices 28 may be of any type suitable for receiving user input including, for example, a keyboard, touchscreen, microphone (for example, for voice input), mouse, touchpad, trackball, or any combination thereof. Output devices 27 may be of any type suitable for providing output to one or more users, whether remote or local to system 20, and may include, for example, one or more screens for visual output, speakers, printers, or any combination thereof. Memory 25 may be RAM having any structure and architecture known in the art for use by processors 21, for example to run software. Storage devices 26 may be any magnetic, optical, mechanical, memristor or electrical storage device for storage of data in digital form (such as those described above, referring to FIG. 2a). Examples of storage devices 26 include flash memory, magnetic hard drive, CD-ROM, and the like.

In some aspects, systems may be implemented on a distributed computing network, such as one having any number of clients and/or servers. Referring now to FIG. 2c, there is a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 2b. In addition, any number of servers 32 may be provided for handling requests received from one or more clients 33. Clients 33 and servers 32 may communicate with one another via one or more electronic networks 31, which may be in various aspects any Internet, wide area network, mobile telephony network (such as CDMA or GSM cellular networks), wireless network (such as WiFi, WiMAX, LTE, and so forth) or local area network (or indeed any network topology known in the art; the aspect does not prefer any one network topology over another). Networks 31 may be implemented using any known network protocols, including, for example, wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored on a server system 32 in the Cloud or on an external service 37 deployed on one or more of a particular enterprise’s or user’s premises. In addition to local storage on servers 32, remote storage 38 may be accessible through the network(s) 31.

In some aspects, clients 33 or servers 32 (or both) may make use of one or more specialized services or appliances that may be deployed locally or remotely across one or more networks 31. For example, one or more databases 34 in either local or remote storage 38 may be used or referred to by one or more aspects. It should be understood by one having ordinary skill in the art that databases in storage 34 may be arranged in a wide variety of architectures and use a wide variety of data access and manipulation means. For example, in various aspects one or more databases in storage 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system or a logical database within an overall database management system. Unless a specific meaning is specified for a given use of the term “database,” it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web system. It should be understood by one having ordinary skill in the art that any configuration or security subsystems known in the art now or in the future may be used in conjunction with aspects without limitation unless a specific security 36 or configuration system 35 or approach is required by the description of any specific aspect.

FIG. 2d shows an exemplary overview of a computer system 40 as may be used in any of the various locations throughout the system. It is exemplary of any computer that may execute code to process data. Various modifications and changes may be made to a computer system 40 without departing from the broader scope of the system and method disclosed herein. A CPU 41 is connected to bus 42, to which bus is also connected to memory 43, non-volatile memory 44, display 47, I/O unit 48, and network interface card (NIC) 53. An I/O unit 48 may, typically, be connected to peripherals such as a keyboard 49, pointing device 50, hard disk 52, real-time clock 51, camera 57, and other peripheral devices. A NIC 53 connects to a network 54, which may be the Internet or a local network, which local network may or may not have connections to the Internet. The system may be connected to other computing devices through the network via a router 55, wireless local area network 56 or any other network connection. Also shown as part of a system 40 is a power supply unit 45 connected, in this example, to a main alternating current (AC) supply 46. Not shown are batteries that could be present and many other devices and modifications that are well known, but are not applicable to, the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles or other integrated hardware devices).

In various aspects, functionality for implementing systems or methods of various aspects may be distributed among any number of client and/or server components. For example, various software modules may be implemented for performing various functions in connection with the system of any particular aspect, and such modules may be implemented to run on server and/or client components.

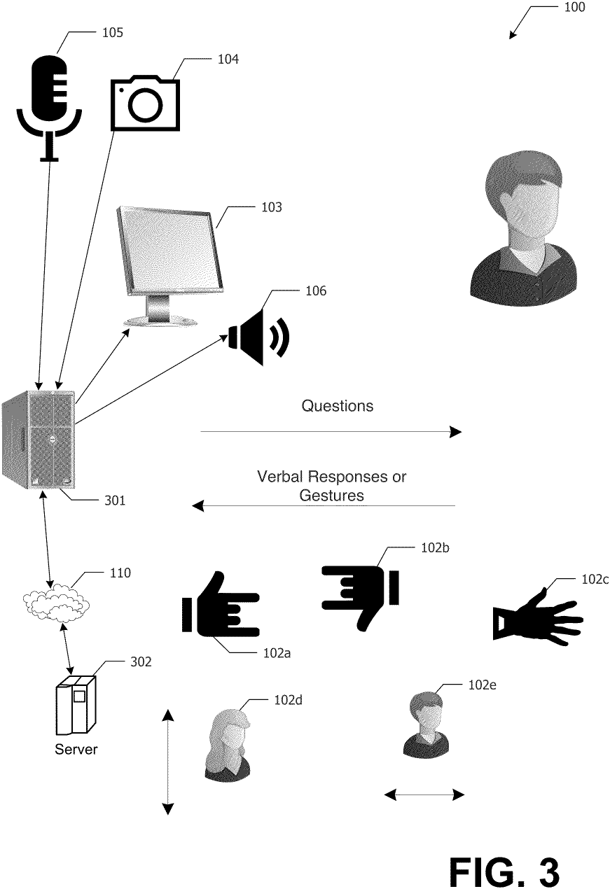

FIG. 3 illustrates an example embodiment of a processing system providing gesture-based query feedback according to the present invention. The user feedback system 100 comprises a feedback computing device 301 coupled to the Internet 110 for communicating with remote computing devices such as a server 302. The feedback computing device 301 also is coupled to the display device 103, the camera 104, the microphone 105, and the speakers 106 to interact with the feedback provider 101.

The feedback computing device 301 provides the feedback provider 101 with a sequence of questions or queries 311 and obtains responses 312 from the feedback provider 101. As disclosed herein the responses 312 comprise one or more gestures 102 that are taught to the feedback provider 101 before the first set of queries. If the feedback provider 101 may use the user feedback system 100 multiple times, such as if the user feedback system 100 is part of a mobile application on a smartphone, the gesture 102 and training responses may be stored within the mobile application and reused to eliminate the need to train the user feedback system 100 and the feedback provider 101 beyond the first use. If subsequent query sessions require additional gestures 102 to generate needed responses from the feedback provider 101, the user feedback system 100 may perform additional training to refresh the memory of the feedback provider 101 as well as teach and learn the additional gestures 102 needed for a particular set of queries.

A simple example of a sequence of queries and responses are:

| | |
|---|---|
| Default Question: | How well did we serve you today? |
| Response: | Customer says “Great”/ “Poorly” “Alright” or gestures “Thumbs Up 102a / Down 102b / Flat 102c” |
| Follow-up question: | Care to share more? |
| Response: | Customer says “yes” 102d or shows another “Thumbs up” 102a and the system starts recording the video until the customer stops. [Without consent, no recording happens.] |

This example utilizes two different types of gestures 102, a position of a user’s hand such as thumbs up 102a, thumbs down 102b, and hand flat 102c, and a directional movement of the head such as up-and-down “yes” and side-to-side “no.” Other gestures 102 that may be utilized are movement of one hand in different directions, use of one or two hands to distinguish responses, and opening, closing, and blinking of one or both eyes to represent different responses. Any combination of these and similar gestures 102 may be mapped onto a set of expected responses taught to the feedback provider 101 for use in a particular query session.

In a possible embodiment, the user feedback system 100 may utilize any set of gestures depending upon the nature of the information being sought by its survey. As noted above, yes/no questions and a small set of responses may be easily utilized in which the feedback system 100 trains a user with a set of gestures 102 to be used. The set of gestures 102 may be tailored to the potential audience for the survey as individuals in different countries may use different languages and customs in which a particular gesture is not appropriate.

In another embodiment, a well-known gesture-based language may be used. For example, many individuals utilize American Sign Language to communicate on a daily basis. The feedback system 100 may be configured to recognize some common gestures from such a language or may attempt to utilize all officially recognized gestures to interact with users taking a survey. The feedback system 100 may also be configured to recognize local dialects of gestures when the particular gestures of a target audience are known in advance. Gestures for American Sign Language are well known and may be reviewed using a website from the National Institute of Health. https://www.nidcd.nih.gov/health/american-sign-language#:~:text=There%20is%20no%20universal%20sign,ASL%20in%20their%20sign%201an guages.

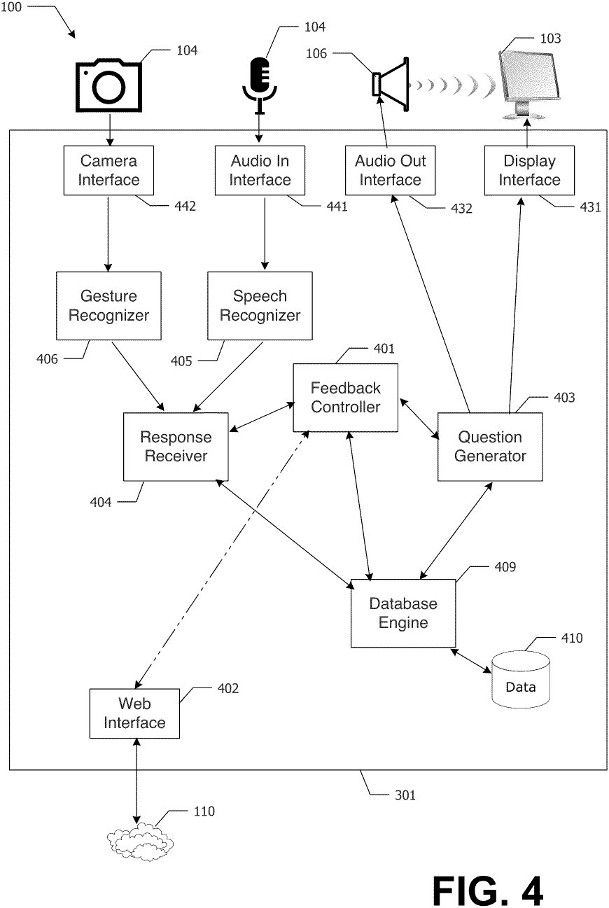

FIG. 4 illustrates a computing system of software components of a system providing gesture-based query feedback according to the present invention. The feedback computing device 301 may be implemented as a set of processing components that perform various data processing functions to implement the user feedback system 100. As disclosed above, the feedback computing device 301 is coupled to the Internet 110 to communicate with remote computing systems. The feedback computing device 301 also comprises a set of peripheral devices to interact with the feedback provider 101. These additional peripherals comprise the display device 103, the camera 104, the microphone 105, and the speakers 106.

The feedback computing device 301 also comprises a set of components including a feedback controller 401, a web interface 402, a question generator 403, a response receiver 404, a speech recognizer 405, a gesture recognizer 406, a database engine 409, a database 410, a display interface 431, an audio out interface 432, an audio in interface 433, and a camera interface 434. Each of these components interact with each other and the peripheral device display device 103-106, to implement the feedback computing device 301.

The feedback controller 401 coordinates the operation of the remaining components web interface 402-442 described herein associated with FIG. 4 to perform the operations of the feedback computing device 301 that implements the user feedback system 100. The feedback controller 401 initiates the query session with the identification of the feedback provider 101 and obtains any user identification data needed. The feedback controller 401 also determines whether training is needed before the sequence of queries that are part of the query session are generated. The feedback controller 401 ensures that the responses and data associated with the feedback provider 101 are included in the database 410. Lastly, the feedback controller 401 communicates with the remote server 302 via the web interface 402 over the Internet 110 to receive query data to be used in query sessions, to communicate health and status of the feedback computing device 301 within the user feedback system 100, and to provide query response data received from a feedback provider 101 and stored into the database 410 for further analysis and use.

The web interface 402 connects the feedback computing device 301 to the Internet 110 to send and receive communication from remote computing systems seeking user feedback. The web interface 401 performs all necessary data formatting, data packet creation, data encryption for security, and data transmission and reception when the feedback computing device 301 communicates with other processing systems disclosed herein. The web interface 402 is also responsible to ensure reception of any communications to other computing systems and to log any errors or attempts to hack into the database 410.

The question generator 403 retrieves query data from the database 410 via the database engine 409 to generate the queries and questions output to the feedback provider 101 via the microphone 105 and the speakers 106. The question generator 403 generates any images, audio data, video data, and related instructions that are to be output to the feedback provider 101. The question generator 403 reformats any data received from the database 410 into the appropriate language, format, and needed characteristics to assist the feedback provider 101 to understand and respond to each query. The question generator 403 may also receive indications of prior responses from the feedback provider 101 that were recognized by the response receiver 404 to guide the question generator 403 to generate subsequent queries. For example, the feedback provider 101 responds to a query regarding the possible presence of an option that may or may not be present on the product that is the subject of the sequence of queries. If the feedback provider 101 responds that the product in question does not possess a particular option, the subsequent queries may omit generating and sending queries related to that particular option to the feedback provider 101 during this particular query session.

The response receiver 404 receives spoken language data from the speech recognizer 405 and receives gesture 102 data from the gesture recognizer 406 to determine the response received from the feedback provider 101 in response to a specific query. The response receiver 404 may inform the feedback controller 401 that a particular response was not recognized to request the feedback provider 101 to reply an additional time to the query until it is recognized. The feedback controller 401 may send the request to re-enter a response to the feedback provider 101 via the question generator 403. The response receiver 404 stores the identified responses from the feedback provider 101 into the database 410 via the database engine 409 along with identification of the query that generated the response, the feedback provider 101 providing the response, the date, location, and time of the response, and all other related data to be included in feedback provider 101 response data sent to the server 302 for use by others.

The speech recognizer 405 receives audio data from the audio in interface 441 and recognizes any spoken language detected within the audio data stream. The speech recognizer 405 performs audio data analysis and language matching functions to detect and identify spoken language in this audio data. The detected spoken language is provided to the response receiver 404 for additional processing to associate the spoken words with one or more queries, gestures 02 occurring simultaneously with one or more gestures 102, to associate the spoken language with an identifiable feedback provider 101, and to associate the spoken language with any related product, query, or user.

The gesture recognizer 406 receives video and image data from the camera interface 442 and recognizes any gestures 102 detected within the image data stream. The gesture recognizer 406 performs imaging data analysis and language matching functions to detect and identify gestures 102 in this image data. The identified gestures 102 are provided to the response receiver 404 for additional processing to associate the gestures 102 with one or more queries, to associate the gestures 102 with an identifiable feedback provider 101, and to associate the gestures 102 with any related product, query, or user.

The database engine 409 processes all database operations for the database 410. These operations include retrieval of query sequences from the database 410, retrieval of gestures 102 from the database 410 corresponding to responses to query sequences, insertion and deletion of query sequences to-from the database 410, insertion and deletion of gestures 102 used to respond to query sequences to-from the database 410, insertion and deletion of responses from feedback provider 101 to query sequences to-from the database 410, searching and retrieving of responses from feedback provider 101 to query sequences to-from the database 410, and indexing the database 101 to maintain efficient searching when needed.

The database 410 is an indexed and searchable datastore for maintaining all of the digital data used by the above components to implement the user feedback system 100. Each of the processing components of the feedback computing device 301 stores data needed to operate within the database 410 and retrieves the data as needed.

The display interface 431 provides output data processing to provide visual data to a feedback provider 101 with queries, gestures 102, instructions and training associated with the gestures 102 and data needed to perform the feedback query functions of the user feedback system 100. This display interface 431 also accepts commands from the feedback controller 401 to instruct the feedback provider 101 to perform necessary tasks.

The audio out interface 432 provides output data processing to provide auditory data to a feedback provider 101 with queries, gestures 102, instructions and training associated with the gestures 102 and data needed to perform the feedback query functions of the user feedback system 100. This audio out interface 432 also accepts commands from the feedback controller 401 to instruct the feedback provider 101 to perform necessary tasks.

The audio in interface 441 provides input data processing to receive audio data from a feedback provider 101 associated with queries, gestures 102, instructions and training associated with the gestures 102 and data needed to perform the feedback query functions of the user feedback system 100. This audio in interface 433 also accepts input from the feedback provider 101 to communicate with the feedback controller 401 to perform necessary tasks.

The camera interface 442 provides input data processing to receive video and image data from a feedback provider 101 associated with queries, gestures 102, instructions and training associated with the gestures 102 and data needed to perform the feedback query functions of the user feedback system 100. This camera interface 442 also accepts input from the feedback provider 101 to communicate with the feedback controller 401 to perform necessary tasks.

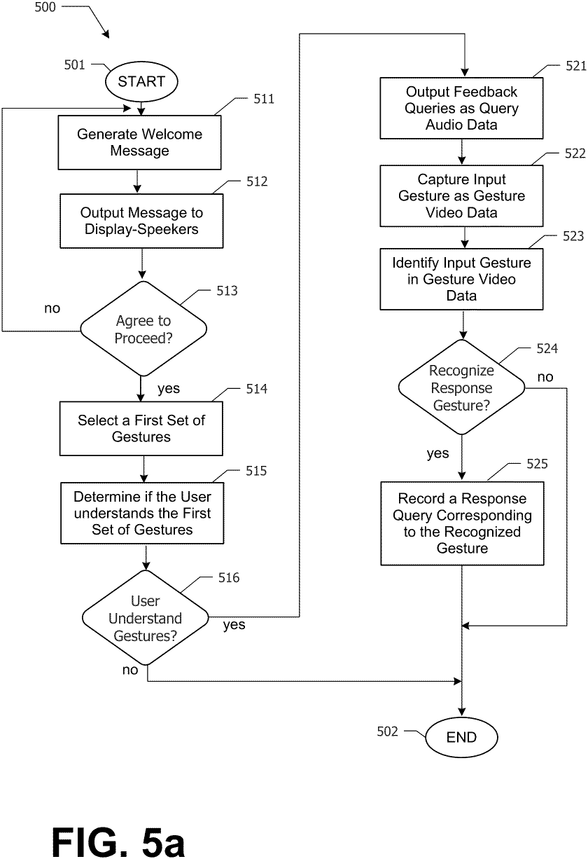

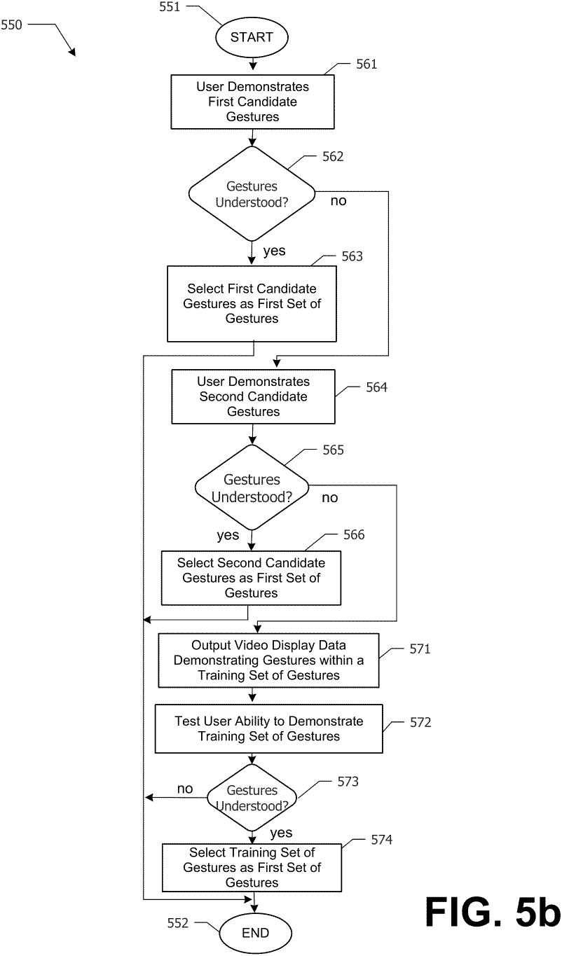

FIG. 5a illustrates a flowchart corresponding to a method performed by software components of a system providing gesture-based query feedback to the present invention. The process 500 to obtain feedback from a user using gestures in response to queries that are part of a survey begins 501 when the system, in step 511, generates a welcome message and outputs the welcome message to a user using the speakers 106 and display device 103 in step 512. In text step 513, the system 100 determines whether the user agrees to proceed to answer the survey, and if not, the process 500 returns to step 511 to wait for another user.

When test step 513 indicates that the user agrees to participate, the system 100 selects a first set of gestures in step 514 for use to generate responses to queries as part of the survey. In step 515, the system 100 tests the user to demonstrate an understanding of the first set of gestures to be used to provide query responses. The system 100 in test step 516 determines whether the user understands the gestures, and if not, the process 500 ends 502; otherwise, the system 100 outputs feedback queries as query audio data to the user via the speakers 106. The feedback queries as spoken language in the native language of the user.

The system, in step 522, captures input gestures from the user as gesture video data using the video camera 104. The system 100 attempts to identify the input gesture received from the user as a recognized gesture in the first set of gestures in step 523. In test step 524, the system 100 determines whether the input gesture is a recognized gesture, and if not, the process 500 ends. When the system determines in test step 524 that the input gesture is recognized as a valid gesture, the process 500 records a query response to the feedback query as the response associated with the recognized gesture in step 525 before the process ends 502. The recorded responses may be used by authors of the survey containing the feedback queries as user feedback.

FIG. 5b illustrates a flowchart corresponding to a method performed by software components of a system a first set of gestures used by a system to provide gesture-based query feedback to the present invention. Before a system 100 can administer a survey, a set of gestures to be used to receive responses from users must be identified. The user and system must confirm that the gestures to be used have a common meaning and that the user can properly demonstrate each gesture that may be needed to ensure that the user may accurately communicate responses to feedback queries.

The gesture selection process 550 begins 561 when the system 100 tests the user 101 by demonstrating each response gesture in a first set of candidate gestures as video data played on the display device 103 and capturing input video data from the video camera 104 when the user demonstrates each response gesture. The system 100 in test step 562 determines whether the response gestures are correctly recognized, and if so, the first set of candidate gestures are set to be the first set of gestures for use in communicating with the user in step 563 and the selection process 550 ends 552.

The system 100 in step 564 tests the user 101 by demonstrating each response gesture in a second set of candidate gestures as video data played on the display device 103 and capturing input video data from the video camera 104 when the user demonstrates each response gesture. The system 100 in test step 565 determines whether the response gestures are correctly recognized, and if so, the second set of candidate gestures are set to be the first set of gestures for use in communicating with the user in step 566 and the selection process 550 ends 552.

When the system 100 determines in test step 565 that the second set of candidate gestures are not recognized, the process 550 outputs video display data demonstrating each individual gesture within a training set of gestures in step 571 and test the user has an ability to demonstrate requested gestures corresponding to each gesture within the output video data in step 572. The system 100 in test step 572 determines whether the response gestures are correctly recognized, and if so, the training first set of gestures are selected as the first set of gestures for use to provide each of the training set of gestures in response to an output request in step 574 and the selection process 550 ends 552; otherwise, the process 550 ends 552 without selecting a first set of gestures.

The embodiments described herein are implemented as logical operations performed by a computer. The logical operations of these various embodiments of the present invention are implemented (1) as a sequence of computer-implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise. Any singular term used in this present patent application is applicable to its plural form even if the singular form of any term is used.

In the present application, all or any part of the invention’s software or application(s) or smart device application(s) may be installed on any of the user’s or operator’s smart device(s), any server(s) or computer system(s) or web application(s) required to allow communication, control, and transfer of content(s) or data between any combination of the components

What is claimed is:

1. A system for providing gesture-based and video-based query feedback received from a user, the system comprising:
a video display device;
a microphone;
a memory having instructions stored thereon; and
a processor configured to execute the instructions on the memory to cause the system to:
select a first set of gestures for use when interacting with the user;
determine whether the user understands the first set of gestures;
when the user understands the first set of gestures, perform the following steps:
output one or more feedback queries as query audio and video data to the user;
capture one or more input gestures as gesture video data in response to the one or more feedback queries;
identify the one or more response gestures within the video data; and
when the one or more gestures identified within the video data are recognized as corresponding to one or more gestures from the first set of gestures, record a query response corresponding to the recognized one or more gestures as a feedback response to the one or more feedback queries.

2. The system according to claim 1, wherein the first set of gestures comprise a first gesture corresponding to a yes response and a second gesture corresponding to a no response as part of a finite set of gestures corresponding to a set of multiple choice responses, a particular feedback query output contains a specified gesture corresponding to each response recognized within the set of multiple choice responses to the particular feedback query.

3. The system according to claim 1, wherein the step of selecting the first set of gestures comprises the processor executing additional instructions to cause the system to:
test the user has an ability to demonstrate requested gestures corresponding to each gesture within a first candidate set of gestures; and
select the first candidate set of gestures as the first set of gestures when the user demonstrates an ability to provide each of the first set of gestures in response to an output request.

4. The system according to claim 3, wherein the step of selecting the first set of gestures further comprises the processor executing additional instructions to cause the system to:
test the user has an ability to demonstrate requested gestures corresponding to each gesture within the second set of gestures in response to an output request.

5. The system according to claim 4, wherein when the user fails to demonstrate all candidate set of gestures, the step of selecting the first set of gestures further comprises the processor executing additional instructions to cause the system to:
output video display data demonstrating each individual gesture within a training set of gestures;
test the user has an ability to demonstrate requested gestures corresponding to each gesture within the output video data; and
select the training first set of gestures as the first set of gestures when the user demonstrates an ability to provide each of the training set of gestures in response to an output request.

6. The system according to claim 1, wherein the first set of gestures comprises gestures used within American Sign Language.

7. The system according to claim 1, wherein the one or more feedback queries are specified using a user spoken language of the user and the recorded responses to the one or more feedback queries are saved using a written language of authors of the feedback queries.

8. The system according to claim 7, wherein the system further comprises the processor executing additional instructions to cause the system to:
generate the query audio data after translating the one or more feedback queries into the user spoken language;
wherein the recorded responses to the one or more feedback queries are output as response audio data to the user; and
the gesture video data used to identify a response gesture is recorded within the query response.

9. The system according to claim 8, wherein gesture video data comprises video images captured by a camera and audio data captured by a microphone of the user response.

10. A method for providing gesture-based query feedback, the method comprising:
selecting a first set of gestures for use when interacting with a user;
determining whether the user understands the first set of gestures;
when the user understands the first set of gestures, perform the following steps:
outputting one or more feedback queries as query audio data to the user;
capturing one or more input gestures as gesture video data in response to the one or more feedback queries;
identifying the one or more response gestures within the video data; and
when the one or more gestures identified within the video data are recognized as corresponding to one or more gestures from the first set of gestures, recording a query response corresponding to the recognized one or more gestures as a feedback response to the one or more feedback queries.

11. The method according to claim 10, wherein the first set of gestures comprise a first gesture corresponding to a yes response and a second gesture corresponding to a no response.

12. The method according to claim 10, wherein the first set of gestures comprise a finite set of gestures corresponding to a set of multiple choice responses, a particular feedback query output contains a specified gesture corresponding to each response recognized within the set of multiple choice responses to the particular feedback query.

13. The method according to claim 10, wherein the step of selecting the first set of gestures comprises:
testing the user has an ability to demonstrate requested gestures corresponding to each gesture within a first candidate set of gestures; and
selecting the first candidate set of gestures as the first set of gestures when the user demonstrates an ability to provide each of the first set of gestures in response to an output request.

14. The method according to claim 13, wherein the step of selecting the first set of gestures further comprises:
testing the user has an ability to demonstrate requested gestures corresponding to each gesture within the second set of gestures in response to an output request.

15. The method according to claim 14, wherein when the user fails to demonstrate all candidate set of gestures, the step of selecting the first set of gestures further comprises:
outputting video display data demonstrating each individual gesture within a training set of gestures;
testing the user has an ability to demonstrate requested gestures corresponding to each gesture within the output video data; and
selecting the training first set of gestures as the first set of gestures when the user demonstrates an ability to provide each of the training set of gestures in response to an output request.

16. The method according to claim 10, wherein the first set of gestures comprises gestures used within American Sign Language.

17. The method according to claim 10, wherein the one or more feedback queries are specified using a user spoken language of the user and the recorded responses to the one or more feedback queries are saved using a written language of authors of the feedback queries.

18. The method according to claim 17, wherein the method further comprising:
generating the query audio data after translating the one or more feedback queries into the user spoken language; and
the recorded responses to the one or more feedback queries are output as response audio data to the user.

19. The method according to claim 17, wherein the gesture video data used to identify a response gesture is recorded within the query response.

20. The method according to claim 19, wherein gesture video data comprises video images captured by a camera and audio data captured by a microphone of the user response.
